(19) United States
(12) Patent Application Publication
(10) Pub. No.: US 2008/0004993 A1
(43) Pub. Date: Jan. 3, 2008

(54) SYSTEM AND METHOD FOR MANAGING PHYSICAL AND LOGICAL ASSETS

(76) Inventors: Jason Alan Horspool, Roy, UT (US); Justin Wayne Gough, North Salt Lake, UT (US); Jacob Brant Gough, North Salt Lake, UT (US)

Correspondence Address: HOLLAND & HART LLP, P.O. Box 11583, 60 E. South Temple, Suite 2000, Salt Lake City, UT, 84110, US

(21) Appl. No.: 11/382,219

(22) Filed: May 8, 2006

(51) Int. Cl. G06Q 10/00

(52) U.S. Cl. 705/28

(57) ABSTRACT

An exemplary method for managing physical or logical assets is disclosed. The method may include providing an information database comprising a plurality of data elements, associating at least one data element in the information database with a first asset, organizing each data element associated with the first asset into a first data element set, associating each data element in the first data element set with at least one data category, and simultaneously displaying each data category associated with each data element in the first data element set. The method may also include associating the first asset with a point, a line, a polygon, or a dynamic coordinate on a map. The method may also include assigning a unique identifier to each data element set contained in the information database. A corresponding system and computer program product are also disclosed.

Recently, the use of Geographical Information Systems (GIS) has increased in the public works and utilities industry. A GIS is a computer-implemented system for storing, displaying, analyzing, and managing geographically referenced information; that is, data identified according to location (also known as “spatial data”). A conventional GIS typically graphically represents the location and shape of, and relationships among, physical assets (such as homes, roads, water lines, and the like) by drawing points, lines (i.e., a series of points), or polygons (i.e., shapes bounded by lines, also known as “areas”) on a map displayed on a display device. Information or attributes relating to a point, line, or polygon displayed on the map on the display device may then be associated with the appropriate point, line, or polygon and stored in a relational database. A user of the GIS (such as a county or city engineer) may then access and retrieve the information associated with each point, line, or polygon in the relational database by selecting a point, line, or polygon on the map displayed on the display device using a user input device, such as a mouse, connected to the GIS. The information and attributes associated with the selected point, line, or polygon may then be displayed on the display device.

Examples of physical assets that may be graphically represented by a GIS include land lots, homes, and businesses (each of which is typically represented by a polygon), wells and manhole covers (each of which is typically represented by a point), and telephone lines, water lines, gas lines, or roads (each of which is typically represented by a line or series of points). Examples of the various types of information or attributes relating to these exemplary assets that may be associated with these assets and stored in the relational database include the address or tax serial number of a home or land lot, a description of the physical condition of a manhole cover, a description of a pending work order associated with a gas line, and the number of car accidents that have occurred at a certain street intersection.

Conventional asset management systems, however, require that each data element entered into the system's database be associated with a previously created geographically referenced. (i.e., map-based) GIS asset, such as a point, line, or polygon. In other words, conventional asset management systems fail to provide a system and method for managing non-geographically referenced assets; i.e., assets that are not associated with or tied to a map. In addition, because each data element stored in the relational database of a conventional asset management system must be directly tied to or associated with a geographically referenced asset, if the location of the geographically referenced asset is edited, the association between the data elements stored in the system's database and the edited asset is typically broken and lost. Thus, the location of GIS assets may not be edited or modified in conventional asset management systems without losing all previously entered information or attributes associated with the edited asset.

Accordingly, there exists a need for an improved method and system for storing, displaying, analyzing, and managing assets.

### SUMMARY

According to at least one embodiment, a method for managing physical or logical assets comprises providing an information database comprising a plurality of data elements, associating at least one data element in the information database with a first asset, organizing each data element associated with the first asset into a first data element set, associating each data element in the first data element set with at least one data category, and simultaneously displaying each data category associated with each data element in the first data element set. The method may also comprise selectively displaying, by data category, each data element in the first data element set.

In certain embodiments, the method may further comprise associating the first asset with at least one of a point, a line, and a polygon on a map. Similarly, the method may comprise associating the first asset with a dynamic coordinate on a map. In addition, the method may comprise associating at least one data element in the information database with a first group of assets and organizing each data element associated with the first group of assets into a second data element set. In an additional embodiment, the method further comprises assigning a unique identifier to each data element set in the information database and/or to each data element in each data element set.

In certain embodiments, the at least one data element represents or contains at least one of an asset attribute, a service request, a work order, a letter, a task, a phone call record, a facsimile, an e-mail, a document, a billing record, a global positioning point, a maintenance schedule, a warranty information record, a construction record, a freehand drawing, and a user definable record. In addition, the method may further comprise remotely accessing the information database over a communication network. In many embodiments, the method may also comprise receiving a request comprising at least one query term, selectively identifying one or more data element sets responsive to the at least one query term, and transmitting a response including the one or more selectively identified data element sets. The method may also comprise associating a service request comprising a plurality of data fields with a second asset, creating a work order corresponding to the service request, with the work order comprising a plurality of data fields, associating the work order corresponding to the service request with the second asset, and dynamically linking at least one data field of the service request to at least one data field of the work order corresponding to the service request.

According to at least one embodiment, an asset management system comprises a display interface and an information database in communication with the display interface, with the information database comprising a first data element set comprising at least one data element and at least one data category associated with each data element in the first data element set. In certain embodiments, each data element in the first data element set may be associated with a first asset and the display interface may enable the simultaneous display of each data category associated with each data element in the first data element set. The first asset may be associated with a point, a line, a polygon, or a dynamic coordinate on a map. In addition, a unique identifier may be assigned to each data element and/or data element set in the information database.

In certain embodiments, the display interface forms a portion of an access device in communication with the information database over a communication network. In addition, the information database may be configured to generate and transmit a response to the access device based upon a request transmitted from the access device, with the request comprising at least one query term and the response comprising at least one data element set responsive to the request. The display interface may also be configured to selectively display, by data category, each data element in the first data element set. According to at least one embodiment, the first data element set comprises a service request comprising a plurality of data fields and a work order corresponding to the service request and comprising a plurality of data fields. In certain embodiments, at least one data field of the service request is dynamically linked to at least one data field of the work order corresponding to the service request.

According to at least one embodiment, a computer program product for managing assets and encoded on a computer-readable medium comprises a first set of machine-readable instructions, executable on a computer system, configured to associate at least one data element in an information database with a first asset, a second set of instructions, executable on the computer system, configured to organize each data element associated with the first asset into a first data element set, a third set of instructions, executable on the computer system, configured to associate each data element in the first data element set with at least one data category, and a fourth set of instructions, executable on the computer system, configured to simultaneously display each data category associated with each data element in the first data element set.

In certain embodiments, a computer-implemented method for managing assets comprises providing an information database comprising a plurality of data elements, associating at least one data element in the information database with a first asset, associating the first asset with a dynamic coordinate on a map, organizing each data element associated with the first asset into a first data element set, assigning a unique identifier to the first data element set, associating each data element in the first data element set with at least one data category, simultaneously displaying each data category associated with the first data element set, and selectively displaying, by data category, each data element in the first data element set.

Features from any of the above-mentioned embodiments may be used in combination with one another in accordance with the general principles described herein. These and other embodiments, features and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary computer system capable of implementing one or more of the exemplary embodiments described and/or illustrated herein;

FIG. 2 is a block diagram of an exemplary networked system capable of implementing one or more of the exemplary embodiments described and/or illustrated herein;

FIG. 3 is a block diagram of an information database according to at least one embodiment;

FIG. 4 is an illustration of an aspect of an exemplary asset management interface;

FIG. 5 is an illustration of an additional aspect of an exemplary asset management interface;

FIG. 6 is an illustration of an additional aspect of an exemplary asset management interface;

FIG. 7 is an illustration of an additional aspect of an exemplary asset management interface;

FIG. 8 is an illustration of an additional aspect of an exemplary asset management interface;

FIG. 9 is an illustration of an additional aspect of an exemplary asset management interface;

FIG. 10 is an illustration of an additional aspect of an exemplary asset management interface;

FIG. 11 is an illustration of an additional aspect of an exemplary asset management interface;

FIG. 12 is an illustration of an additional aspect of an exemplary asset management interface;

FIG. 13 is a flow diagram of an exemplary method for managing assets;

FIG. 14 is a flow diagram of an exemplary method for identifying one or more data element sets responsive to a search request; and

FIG. 15 is a flow diagram of an exemplary method for dynamically associating a work order with a corresponding service request.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, one of skill in the art will understand that the exemplary embodiments described herein are not intended to be limited to the particular forms disclosed. Rather, the instant disclosure covers all modifications, equivalents, and alternatives falling within the scope defined by the appended claims.

### DETAILED DESCRIPTION OF EXEMPLARY EMBODIMENTS

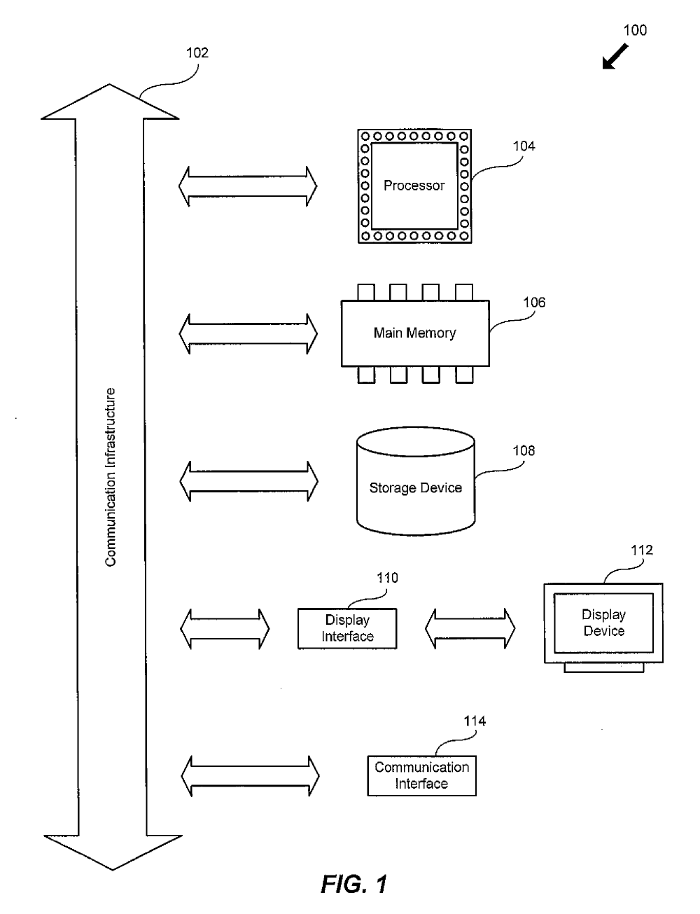

FIG. 1 is a block diagram of an exemplary computer system 100 capable of implementing one or more of the exemplary embodiments described and/or illustrated herein. Computer system 100 generally represents any single or multi-processor computer or computer system capable of executing single-threaded or multi-threaded applications. As seen in FIG. 1, exemplary computer system 100 may comprise one or more processors 104 coupled to a communication infrastructure 102. Communication infrastructure 102 generally represents any form or structure capable of facilitating communication between one or more electronic components; including, for example, a communication bus (such as an ISA or PCI bus) or a network. In at least one embodiment, computer system 100 also comprises a main memory 106 and a storage device 108 operably coupled to processor 104 via communication infrastructure 102.

Main memory 106 generally represents any form of storage device or medium capable of storing data and other computer-readable instructions; including, for example, a random access memory (RAM) unit. Similarly, storage device 108 generally represents any form of storage device or medium capable of storing data and other computer-readable instructions. For example, storage drive 108 may be a magnetic disk drive (e.g., a so-called hard drive), a floppy disk drive, a magnetic tape drive, an optical disk drive, a flash drive, or the like. In certain embodiments, storage device 108 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage device 108 may also comprise other similar structures for allowing computer software, data, or other computer-readable instructions to be loaded into computer system 100. For example, storage device 108 may comprise a program cartridge and an associated cartridge interface, a removable memory chip (such as a flash memory chip, an EEPROM, EPROM, PROM, FRAM, MRAM, or other similar non-volatile memory chip) and associated socket, and other removable storage units and interfaces configured to allow software and data to be transferred from the removable storage unit to computer system 100.

In many embodiments, computer system 100 also comprises a display interface 110 configured to forward graphics, text, and other data from communication infrastructure 102 (or from a frame buffer, as known in the art) for display on a display device 112. Display device 112 generally represents any form of device capable of visually displaying information forwarded by display interface 110. Examples of display device 112 include, without limitation, CRT monitors, LCD screens, plasma screens, video projectors, and the like. As seen in FIG. 1, computer system 100 may also comprise a communication interface 114. Communication interface 114 generally represents any structure or device capable of enabling wired or wireless communication between computer system 100 and an external device. For example, communication interface 114 may represent a modem, a network interface (such as a network interface card), a communication port, or the like.

As discussed in greater detail below, one or more of the exemplary embodiments described and/or illustrated herein may be implemented as control logic in exemplary computer system 100 using any number of software, firmware, and hardware configurations. For example, one or more of the exemplary embodiments disclosed herein may be encoded as a computer program (also known as computer software, software applications, computer-readable instructions, or computer control logic) and stored in a computer-readable medium. The computer-readable medium containing the computer program may then be loaded into computer system 100 using a removable storage drive or downloaded to computer system 100 via communication interface 114 over a communication path, such as over the Internet or other network. All or a portion of the computer program stored on the computer-readable medium may then be stored in main memory 106 and/or various portions of storage device 108. When executed by processor 104, a computer program loaded into computer system 100 may cause processor 104 to perform the functions of one or more of the exemplary embodiments described and/or illustrated herein. As used herein, the phrase “computer-readable medium” generally refers to a storage device or medium capable of storing a computer program. As detailed above, examples of such media include magnetic media, optical media, flash media, or other recordable media. Similarly, computer-readable medium may refer to media that transmit or receive a carrier wave or other signal.

Additionally or alternatively, one or more of the exemplary embodiments described and/or illustrated herein may be implemented in firmware and/or hardware. For example, one or more of the exemplary embodiments disclosed herein may be implemented using various hardware components such as, for example, application specific integrated circuits (ASICs). Implementation of a hardware state machine for performing the functions described herein will be apparent to persons skilled in the art.

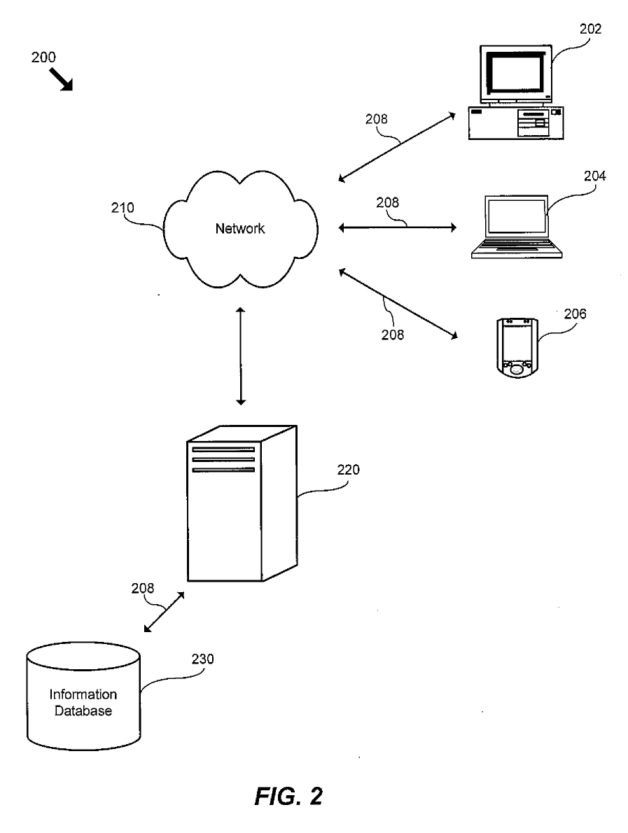

FIG. 2 is a block diagram of an exemplary networked system 200 capable of implementing one or more of the exemplary embodiments described and/or illustrated herein. As seen in this figure, in at least one embodiment exemplary networked system 200 comprises a plurality of access devices 202, 204, and 206 in communication with a server 220 over a network 210. Access devices 202, 204, and 206 generally represent various computing devices; including, for example, a laptop, a notebook, a desktop, a personal digital assistant (PDA), a handheld, or other computing device, such as computer system 100 in FIG. 1. In certain embodiments, access devices 202, 204, and 206 may comprise a display and one or more input devices, such as a keyboard, pointing device, or other input device known to those skilled in the art. In at least one embodiment, access devices 202, 204, and 206 are connected to network 210 via one or more connections 208. Connections 208 may consist of any form of connection recognized in the art; including, for example, telephone wires, network cables, wireless communication links, fiber optic cables, or the like.

Network 210 generally represents any telecommunication or computer network known to those of skill in the art; including, for example, an intranet, a wide area network (WAN), a local area network (LAN), a personal area network (PAN), or the Internet. In at least one embodiment, access devices 202, 204, and 206 may be configured to run a Web browser. Access devices 202, 204, and 206 may also be configured to communicate with server 220 over network 210 using any number of protocols or formats; including, for example, HyperText Transport Protocol (HTTP), Really Simple Syndication (RSS), and/or Extensible Markup Language (XML).

As illustrated in FIG. 2, exemplary networked system 200 may also comprise an information database 230 in communication with server 220 via one or more connections 208. Server 220 generally represents a computing device, such as an application server or database server, configured to provide various database services and/or to run certain software applications. Similarly, information database 230 generally represents any form of storage device or medium capable of storing data and other computer-readable instructions. Although depicted in FIG. 2 as physically separate devices, in some embodiments server 220 and information database 230 exist on a single physical computing device and/or are embodied in a single software application. In addition, networked system 200 may include more than one server 220 and/or more than one information database 230.

In at least one embodiment, all or a portion of one or more of the exemplary embodiments disclosed herein may be encoded as a computer program and loaded onto and executed by server 220, information database 230, access devices 202, 204, and 206, or any combination thereof. For example, all or a portion of one or more of the exemplary embodiments disclosed herein may be encoded as a computer program, stored in server 220 and/or information database 230, run by server 220, and distributed to access devices 202, 204, and 206 over network 210. Additionally or alternatively, all or a portion of one or more of the exemplary embodiments disclosed herein may be encoded as a computer program and loaded onto and executed by a single computing device, such as computer system 100 or access devices 202, 204, and 206. Access devices 202, 204, and 206 may also access one or more data elements stored in information database 230 by communicating with server 220 over network 210.

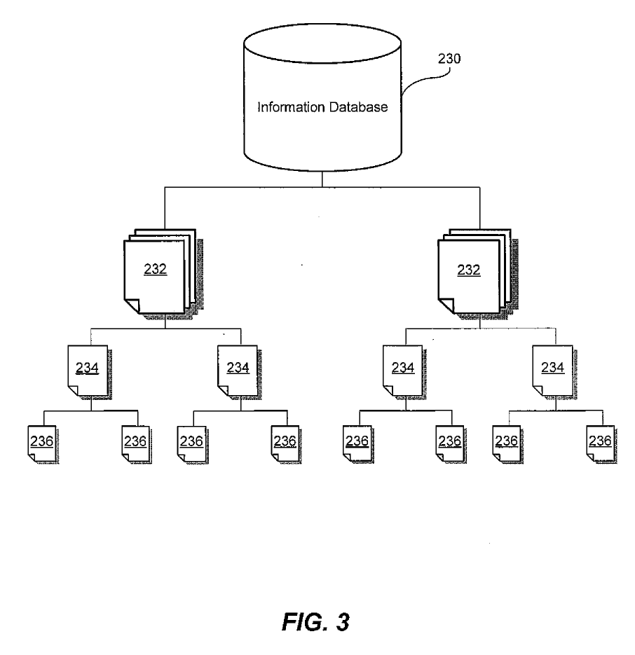

FIG. 3 is a block diagram of an information database 230 according to at least one embodiment. As detailed above, information database 230 generally represents any form of storage device or medium capable of storing data and other computer-readable instructions. In at least one embodiment, information database 230 represents a storage device contained within a single computing device, such as storage device 108 in computer system 100. In an additional embodiment, information database 230 may represent a storage device in communication with a networked server, such as information database 230 and server 220 in FIG. 2.

As seen in FIG. 3, information database 230 may comprise a plurality of data elements 236. Data elements 236 generally represent discrete data entries in information database 230. In at least one embodiment, data elements 236 generally represent any type of information or attribute associated with an asset, such as a piece of property, a street or intersection, a utility line, an irrigation valve, or the like. For example, data elements 236 may represent or contain data or information relating to the mailing address or owner of a home, the tax serial number, tax district or acreage of a piece of real property, a description of the physical condition of an irrigation valve, the amount of current carried over a power line, or the name of a street. Data elements 236 may also contain information relating to trackable events associated with an asset. For example, data elements 236 may contain information relating to the number of car accidents that have occurred at a certain street intersection, the number of phone calls or facsimiles received from a homeowner, the amount of rainfall that has occurred within the past year on a piece of real property, or the like.

In addition, data elements 236 may represent or contain files or documents associated with an asset. For example, data elements 236 may represent or contain a service request record indicating service activities that need to be performed in connection with an asset, a work order record indicating the steps that must be undertaken and/or the resources that must be used in completing a service request, a task record indicating a job or assignment that needs to be undertaken relative to an asset, a note record containing text-based descriptions of various aspects of an asset, a letter sent or received in connection with an asset, a record of a phone call placed or received in connection with an asset, a record of a facsimile or e-mail sent or received in connection with an asset, a billing record indicating billing or accounting information relative to an asset, a maintenance schedule indicating the dates required for performing maintenance operations on a particular asset, a warranty information record that indicates the warranty or time of purchase of an asset, a building/construction record containing information relating to building permits and/or other construction information associated with an asset, a freehand or computer-generated drawing depicting various aspects of an asset, a global positioning system (GPS) point containing GPS information relative to an asset, and/or a user definable record containing custom fields and data entries definable by a user.

In at least one embodiment, and as will be explained in greater detail below, each data element 236 contained in information database 230 is associated with or linked to an asset or a group of assets. These assets may either be physical or logical. For example, each data element 236 may be associated with a physical asset, such as a piece of property (such as a home lot), a utility line (such as a gas or water line), or a relatively small physical object (such as an irrigation valve or manhole cover), or a logical asset, such as electronic currency or an electronic transaction. These assets may also be geographically referenced or non-geographically referenced. In other words, data elements 236 may be associated with an asset that is linked or tied to a map (i.e., a geographically referenced asset) or with an asset that is not linked or tied to a map (i.e., non-geographically referenced asset). Examples of geographically referenced assets include assets that are graphically represented by a point, line, polygon, or dynamic coordinate on a map.

In many embodiments, each data element 236 that is associated with a particular asset (either physical, logical, geographically referenced, or non-geographically referenced) is organized into and classified within a single data element set 232. In other words, each data element 236 that is associated with or linked to the same asset (such as a gas line) may be organized into and classified within a common data element set 232. Accordingly, in at least one embodiment, every data element 236 within a single data element set 232 is associated with or linked to a common (i.e., the same) asset. Additionally or alternatively, data elements 236 in information database 230 may be associated with a group of assets, such as a plurality of homes in a subdivision, as opposed to a single asset.

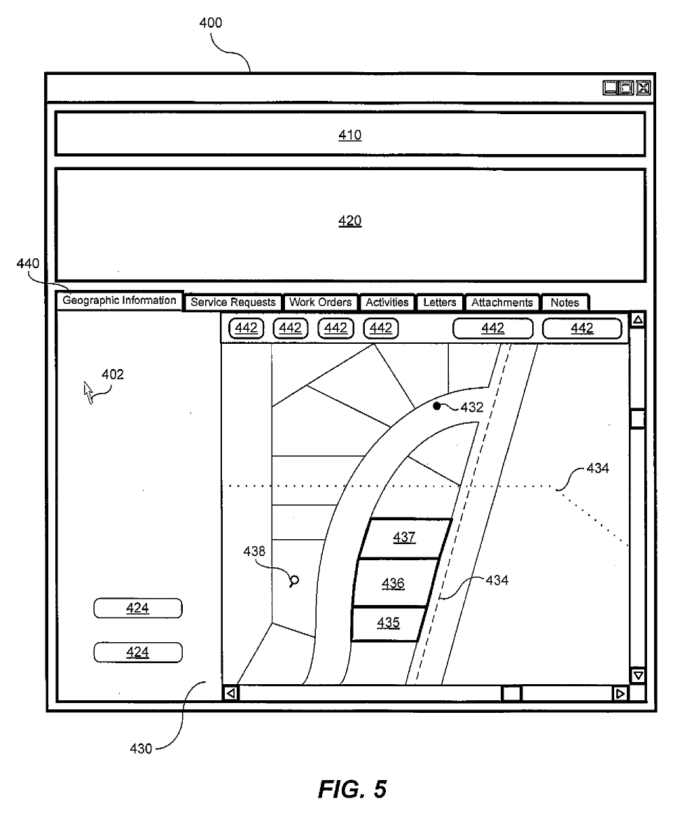

As illustrated in FIG. 3, each data element 236 stored in information database 230 may also be associated with at least one data category 234. Data categories 234 generally represent the various types and categories of data elements 236 that may be stored in information database 230. Examples of suitable data categories 234 include, without limitation, services requests, work orders, activities, letters, attachments, notes, drawings, and geographic information. In at least one embodiment, as illustrated in FIG. 3, each data element 236 is organized within each data element set 232 by data category 234. In addition, as discussed in greater detail below in connection with FIGS. 5-12, each data element 236 and/or each data element set 232 within information database 230 may be assigned a unique identifier. In certain embodiments, the identifier assigned to each data element 236 and/or each data element set 232 may comprise a string of one or more letters and/or numbers. Further, the identified assigned to each data element 236 and/or each data element set 232 may be chosen so as to be unique and different from every other identifier assigned to every other data element 236 and data element set 232.

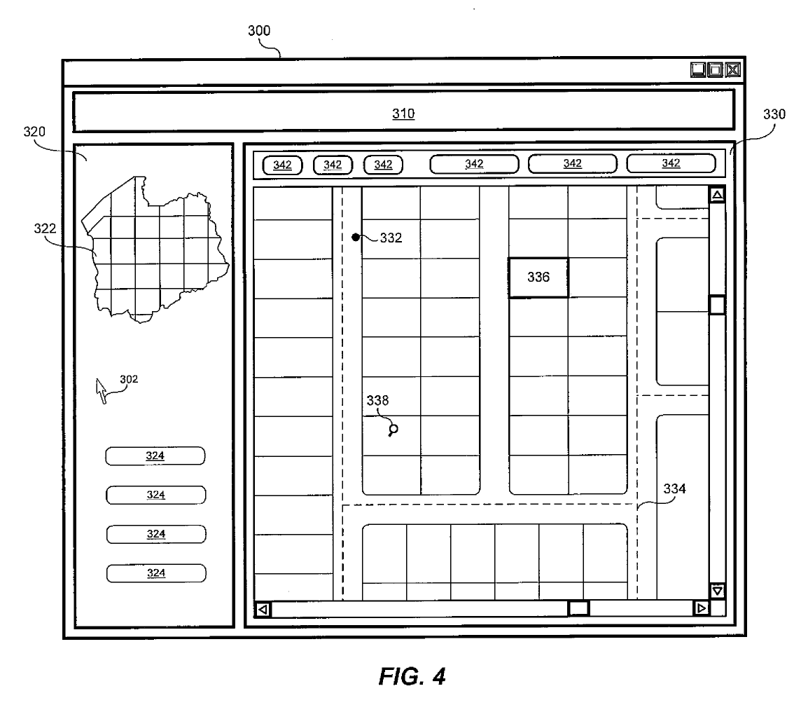

FIG. 4 is an illustration of a portion of an exemplary asset management interface. Generally speaking, the exemplary asset management interface illustrated in FIG. 4 may be displayed on a display device (such as display device 112 in FIG. 1) to provide a user of the asset management system with a convenient, visual mechanism for controlling the operation of the asset management system. As seen in FIG. 4, in at least one embodiment an exemplary asset management interface comprises a display area 300 displayed on a display device (such as display device 112 in FIG. 1) and divided into a first display area 310, a second display area 320, and a third display area 330.

In certain embodiments, the exemplary asset management interface illustrated in FIG. 4 may comprise various types of menus and control objects to provide input and output functionality. Examples of suitable control objects include, without limitation, push buttons, by which a user may indicate acceptance of a particular action, radio buttons for selecting one of a number of available choices for a particular parameter, and check boxes for activating or deactivating various features. Additional examples of control objects include scroll bars for displaying different portions of a display area within a display window, sliders for adjusting variable values, and minimization buttons for displaying or hiding the contents of a folder or a pop-up menu.

In many embodiments, a user may activate one or more of these various control objects by positioning a cursor, such as cursor 302 in FIG. 4, above the control object using a user input device (such as a mouse) connected to the asset management system, and actuating the object by pushing a button or the like on the user input device. Selection of menu items may occur in a similar manner. For example, a user may position the cursor over a desired command displayed on a menu, and then press or release a control button on the user input device. When this occurs, the asset management system may detect the position of the cursor, and if it is located over a menu command or a control object, execute the function associated with the selected control object or menu command.

For example, in at least one embodiment, the exemplary asset management interface illustrated in FIG. 4 may comprise a plurality of navigation buttons 324 provided in second display area 320 and a plurality of action buttons 342 provided in third display area 330. In certain embodiments, navigation buttons 324 may be associated with various navigation functions. In particular, navigation buttons 324 may correspond to, and allow a user to select between, one or more views of information for display in third display area 330. Examples of the type of text or graphics-based data or information that may be displayed in third display area 330 include, without limitation: 1) a list and description of each of the data element sets 232 stored in information database 230; 2) a list and description of all pending tasks associated with each data element set 232 stored in information database 230; 3) a list and description of all pending service requests associated with each data element set 232 stored in information database 230; 4) a list and description of all pending work orders associated with each data element set 232 stored in information database 230; 5) an inventory list detailing the availability and/or allocation of all equipment or parts owned by an entity (such as a public works or utilities entity); 6) a contacts list providing contact information for each individual and entity associated with the asset management system; 7) a calendar that displays various appointments and deadlines associated with each data element set 232; 8) a report interface configured to display and allow a user to select and/or create various reports associated with each data element 236 and/or data element set 232 stored in information database 230; and 9) a map configured to display geographical representations of each asset located within a selected geographical region (as illustrated and described in connection with FIG. 4). In at least one embodiment, a user may navigate between these various exemplary views and types of information by selecting navigation buttons 324 using a user input device, such as a mouse.

Similarly, action buttons 342 may correspond to, and allow a user to select, various actions or functions that may be performed by the asset management system. Examples of actions that may be performed upon actuation of action buttons 342 may include, without limitation: 1) a zoom operation for zooming in and out of a map display; 2) a print operation for printing the area displayed within third display area 330; 3) a save operation; 4) a refresh operation for refreshing third display area 330; and 5) a select operation for allowing a user to select one or more of the points 332, lines 334, polygons 336, or dynamic coordinates 338 displayed in third display area 330. A user may also switch between the various types of data element sets 232 (i.e., data element sets relating to physical assets, logical assets, geographically referenced assets, and non-geographically referenced assets) by actuating action buttons 342.

As detailed above, third display area 330 may be configured to selectively display graphical representations of each asset or group of assets located within a particular geographical region. For example, as seen in FIG. 4, the location of an asset or a group of assets may be graphically represented or indicated by a point 332, a line 334, a polygon 336, or a dynamic coordinate 338 drawn on a map in third display area 330. In many embodiments, points 332 are used to represent relatively small objects, such as manhole covers, irrigation valves, wells, and the like. In addition, lines 334 (which may be formed, for example, by a series of points) may be used to represent continuous objects, such as utility lines (such as gas, power, or water lines), streets, or intersections. Similarly, polygons 336 (i.e., shapes bounded by lines) may be used to represent, for example, a home, a business, a piece of real property, or the like.

In addition, a dynamic coordinate 338 may be used to dynamically indicate the location of an asset, a group of assets, or a portion of an asset on a map. Dynamic coordinate 338 generally represents a marker relating to an X, Y coordinate on a map that may be moved, repositioned, or manipulated as desired. In at least one embodiment, dynamic coordinate 338 may be associated with a logical pointer that is associated with a data element 236. For example, this logical pointer may update data fields in data element 236 relating to the X, Y position of dynamic coordinate 338 as dynamic coordinate 338 is moved about the map. Thus, because the data element 236 is associated with the logical pointer associated with dynamic coordinate 338, as opposed to being associated with a fixed graphical representation of an asset (such as point 332, line 334, or polygon 336), data element 236 may remain associated with dynamic coordinate 338 as coordinate 338 is repositioned and moved about the map. Accordingly, the location of dynamic coordinate 338 may be edited by a user without breaking the association between dynamic coordinate 338 and the data element(s) 236 associated with this coordinate 338 in information database 230.

In certain embodiments, a navigation map 322 may be displayed in second display area 320. As seen in FIG. 4, navigation map 322 may graphically represent various geographical boundaries and locations, such as a county, a city, a state, a nation, or the world. In at least one embodiment, a user may navigate between the geographical regions that are displayed in third display area 330 by selecting a geographical region displayed in navigation map 322. For example, a user may select a county to be displayed within third display area 330 by positioning a cursor 302 over the portion of navigation map 322 that is desired to be displayed in third display area 330 using a user input device, such as a mouse, and then selecting the desired location using the user input device. A user may also zoom in and out of the map displayed in third display area 330 by actuating one or more action buttons 342.

In at least one embodiment, attributes and/or information contained in the data elements 236 associated with one or more of the assets graphically represented in third display area 330 may be displayed in first display area 310. For example, first display area 310 may display information relating to the mailing address or owner of a home (represented by, for example, polygon 336), the tax serial number, tax district, or acreage of a piece of real property (represented by, for example, polygon 336), a description of the physical condition of an irrigation valve (represented by, for example, point 332), the amount of current carried over a power line (represented by, for example, line 334), or the name of a street (represented by, for example, line 334).

FIG. 5 is an illustration of an additional aspect of an exemplary asset management interface comprising a display area 400 divided into a first display area 410, a second display area 420, and a third display area 430. In at least one embodiment, display area 400 may be configured to display text and/or graphics-based data and information associated with a selected data element set 232. For example, first display area 410 may be configured to display a unique identifier, discussed in greater detail above, associated with the selected data element set 232. Similarly, second display area 420 may be configured to display attributes and/or information associated with the assets or groups of assets associated with the selected data element set 232. In at least one embodiment, as described in greater detail above, this attribute and information data may be stored in one or more data elements 236 associated with the chosen data element set 232. Examples of the types of attribute and information data that may be displayed in first and second display areas 410, 420 include, without limitation, the postal address of a home (represented by, for example, polygon 436), the tax serial number, tax district, or acreage of a piece of real property (represented by, for example, polygon 436), a description of the physical condition of an irrigation valve (represented by, for example, point 432), the amount of current carried over a power line (represented by, for example, line 434), the name of a street (represented by, for example, line 434), or the X, Y coordinate currently associated with a dynamic coordinate 438.

In at least one embodiment, third display area 430 may be configured to simultaneously display each data category 234 that is associated with a selected data element set 232. For example, as illustrated in FIGS. 5-12, third display area 430 may be configured to display one or more data category tabs 440 relating to each data category 234 associated with the selected data element set 232. Examples of suitable data categories 234 and data category tabs 440 include, without limitation, service requests, work orders, activities, letters, attachments, notes, drawings, and geographic information. In addition, as with display area 300, display area 400 may comprise a plurality of navigation buttons 424 associated with various navigation functions and a plurality of action buttons 442 associated with various actions that may be performed by the asset management system.

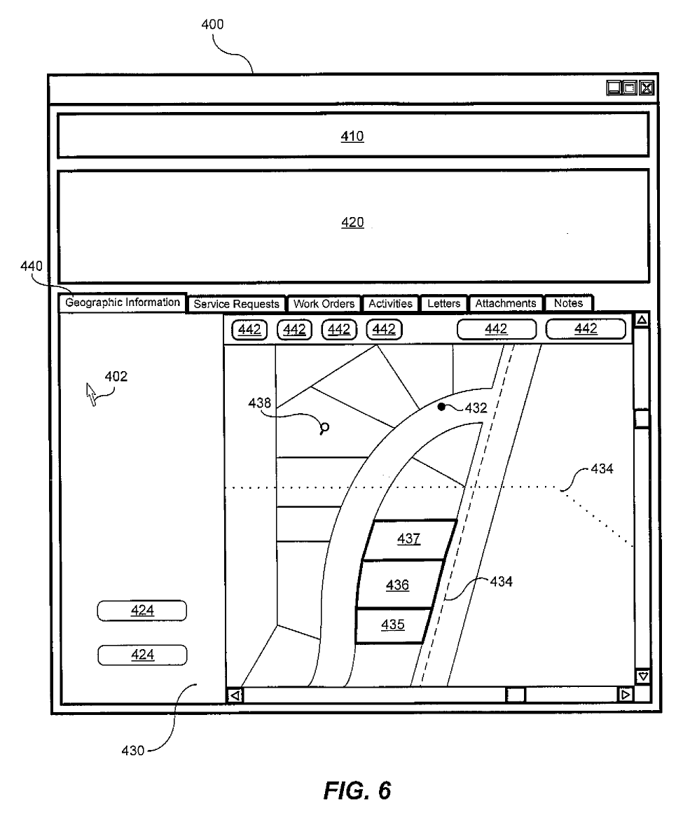

In certain embodiments, third display area 430 may also be configured to selectively display, by data category, all data and information (including all data elements 236) associated with a selected data element set 232. For example, as illustrated in FIG. 5, all geographic information associated with a selected data element set 232 may be displayed within third display area 430 by selecting the data category tab 440 labeled “Geographic Information.” Similarly, as illustrated in FIGS. 6-12, each service request, work order, activity, letter, attachment, note, or drawing associated with a selected data element set 232 may be displayed within third display area 430 by selecting the data category tab 440 corresponding to the desired data category 234.

As illustrated in FIGS. 5 and 6, all geographic information associated with a selected data element set 232 may be displayed within third display area 430 by selecting the data category tab 440 labeled “Geographic Information.” In particular, the location of an asset or a group of assets may be graphically represented or indicated within third display area 430 by a point 432, a line 434, a polygon 436 (or a group of polygons 335, 436, and 437), or a dynamic coordinate 438 drawn on a map. As detailed above, points 432 may be used to represent relatively small objects, such as manhole covers, irrigation valves, wells, and the like. In addition, lines 434 (which may be formed, for example, by a series of points) may be used to represent continuous objects, such as utility lines (such as gas, power, or water lines), streets, or intersections. Similarly, polygons 436 (i.e., shapes bounded by lines) may be used to represent, for example, a home, a business, a piece of real property, a subdivision (represented by, for example, a group of polygons 435-437), or the like.

In addition, a dynamic coordinate 438 may be used to dynamically indicate the location of an asset, a group of assets, or a portion of an asset on a map. As detailed above, dynamic coordinate 438 generally represents a marker relating to an X, Y coordinate on a map that may be moved, repositioned, or manipulated as desired. In at least one embodiment, dynamic coordinate 438 may be associated with a logical pointer that is associated with a data element 236. For example, this logical pointer may update data fields in data element 236 relating to the X, Y position of dynamic coordinate 438 as dynamic coordinate 438 is moved about the map. Thus, because the data element 236 is associated with the logical pointer associated with dynamic coordinate 438, as opposed to being associated with a fixed graphical representation of an asset (such as point 432, line 434, or polygon 436), data element 236 may remain associated with dynamic coordinate 438 as coordinate 438 is repositioned and moved about the map. Accordingly, dynamic coordinate 438 may be moved from a first location, illustrated in FIG. 5, to a second location, illustrated in FIG. 6, without breaking the association between the dynamic coordinate 438 and the data element(s) 236 associated with this coordinate 438 in information database 230.

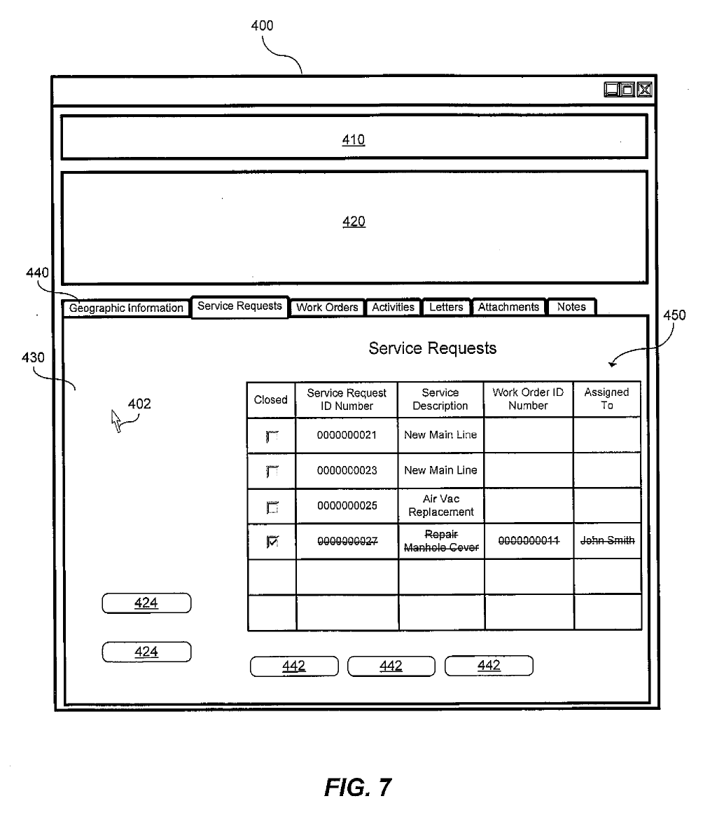

As illustrated in FIG. 7, a listing 450 of information relating to each service request associated with a selected data element set 232 may be displayed within third display area 430 by selecting the data category tab 440 labeled “Service Requests.” In at least one embodiment, listing 450 comprises a plurality of data fields, one or more of which may be stored as a data element 236 in information database 230, as discussed in greater detail above. Examples of the type of data and information that may be entered or stored in each data field of listing 450 include, without limitation, a service request identification number, a description of the service requested, a work order identification number created in response to the service request, and the names of individuals assigned to complete the service request. In certain embodiments, one or more files containing each search request displayed in listing 450 may be stored as a data element 236 in information database 230 and displayed as an attachment in third display area 430.

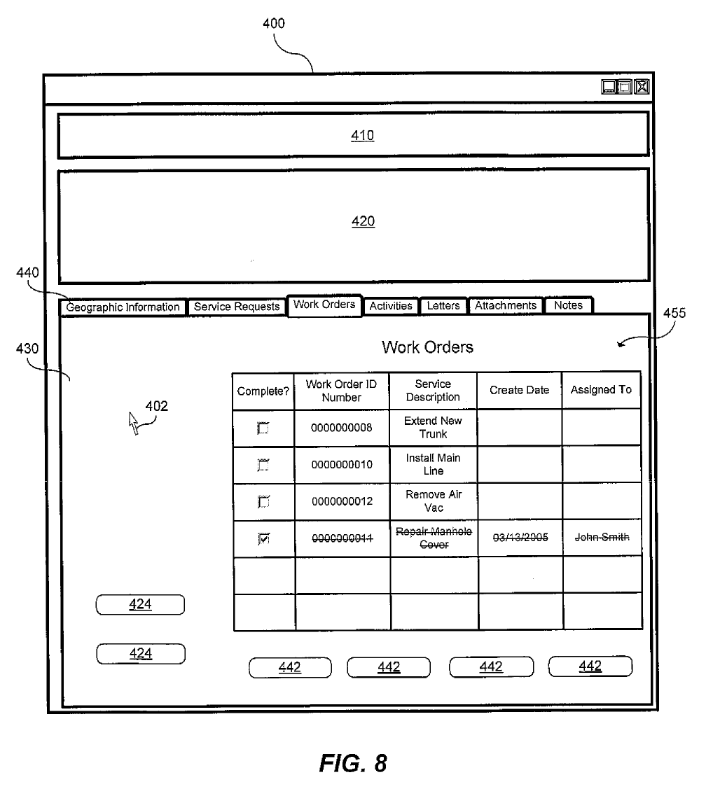

As illustrated in FIG. 8, a listing 455 of information relating to each work order associated with a selected data element set 232 may be displayed within third display area 430 by selecting the data category tab 440 labeled “Work Orders.” In at least one embodiment, listing 455 comprises a plurality of data fields, one or more of which may be stored as a data element 236 in information database 230, as discussed in greater detail above. Examples of the type of data and information that may be entered or stored in each data field of listing 455 include, without limitation, a work order identification number, a description of the services to be performed, the date on which the work order was created, and the names of individuals assigned to complete the work order. In certain embodiments, one or more files containing each work order displayed in listing 455 may be stored as a data element 236 in information database 230 and displayed as an attachment in third display area 430.

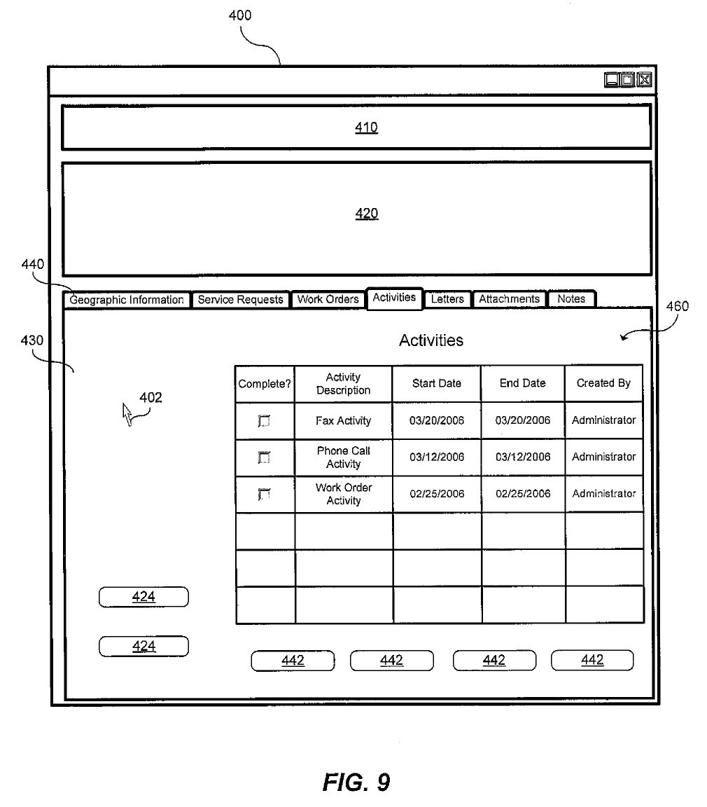

Similarly, as illustrated in FIG. 9, a listing 460 of information relating to each activity (such as a phone call, a facsimile, an e-mail, or the like) associated with a selected data element set 232 may be displayed within third display area 430 by selecting the data category tab 440 labeled “Activities.” In at least one embodiment, listing 460 comprises a plurality of data fields, one or more of which may be stored as a data element 236 in information database 230, as discussed in greater detail above. Examples of the type of data and information that may be entered or stored in each data field of listing 460 include, without limitation, a description of the activity (such as a phone call, e-mail, or facsimile) that was performed, the date on which the activity began, the date on which the activity ended, and the names of individuals involved in the activity. In certain embodiments, one or more files containing a record of each activity displayed in listing 460 may be stored as a data element 236 in information database 230 and displayed as an attachment in third display area 430.

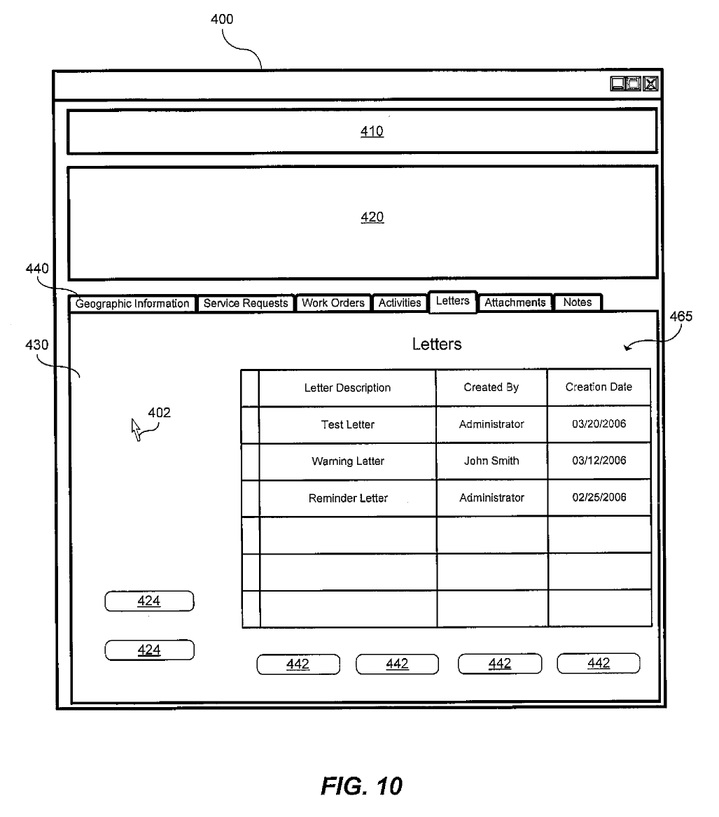

In addition, as illustrated in FIG. 10, a listing 465 of information relating to each letter drafted, sent, or received in connection with a selected data element set 232 may be displayed within third display area 430 by selecting the data category tab 440 labeled “Letters.” In at least one embodiment, listing 465 comprises a plurality of data fields, one or more of which may be stored as a data element 236 in information database 230, as discussed in greater detail above. Examples of the type of data and information that may be entered or stored in each data field of listing 465 include, without limitation, a description of the type of letter that was drafted, sent, or received, the date on which the letter was drafted, sent, or received, and the name of an individual involved in drafting, receiving, or sending the letter. In certain embodiments, one or more files containing each letter displayed in listing 465 may be stored as a data element 236 in information database 230 and displayed as an attachment in third display area 430.

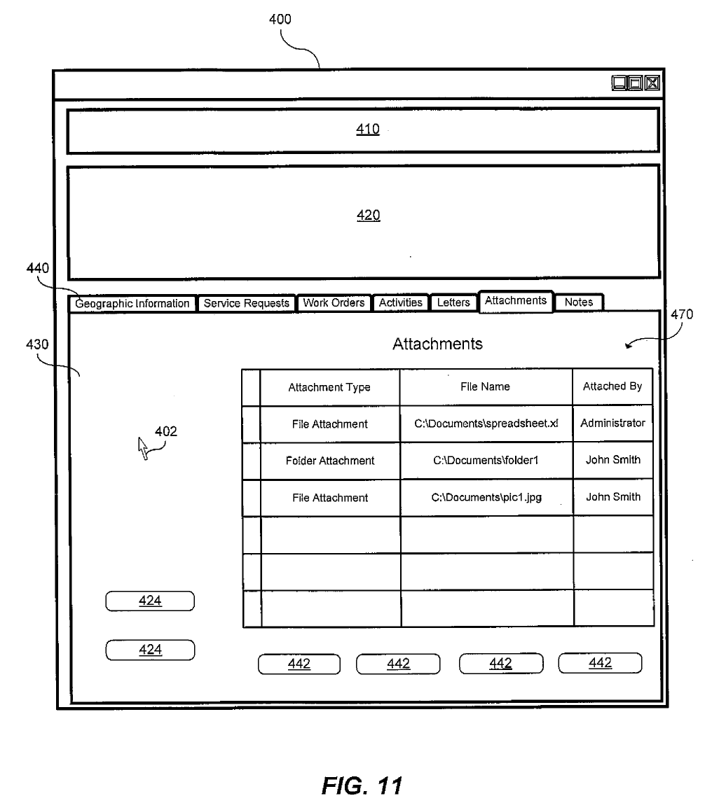

Similarly, as illustrated in FIG. 11, a listing 470 of information relating to miscellaneous files or documents associated with or “attached” to a selected data element set 232 may be displayed within third display area 430 by selecting the data category tab 440 labeled “Attachments.” In at least one embodiment, listing 470 comprises a plurality of data fields, one or more of which may be stored as a data element 236 in information database 230, as discussed in greater detail above. Examples of the type of data and information that may be entered or stored in each data field of listing 470 include, without limitation, a description of the type of file or document attached to the data element set 232, the name of the attached file or document, and the name of the individual responsible for attaching the file or document to the data element set 232. In certain embodiments, one or more files containing each file or document displayed in listing 470 may be stored as a data element 236 in information database 230 and displayed as an attachment in third display area 430.

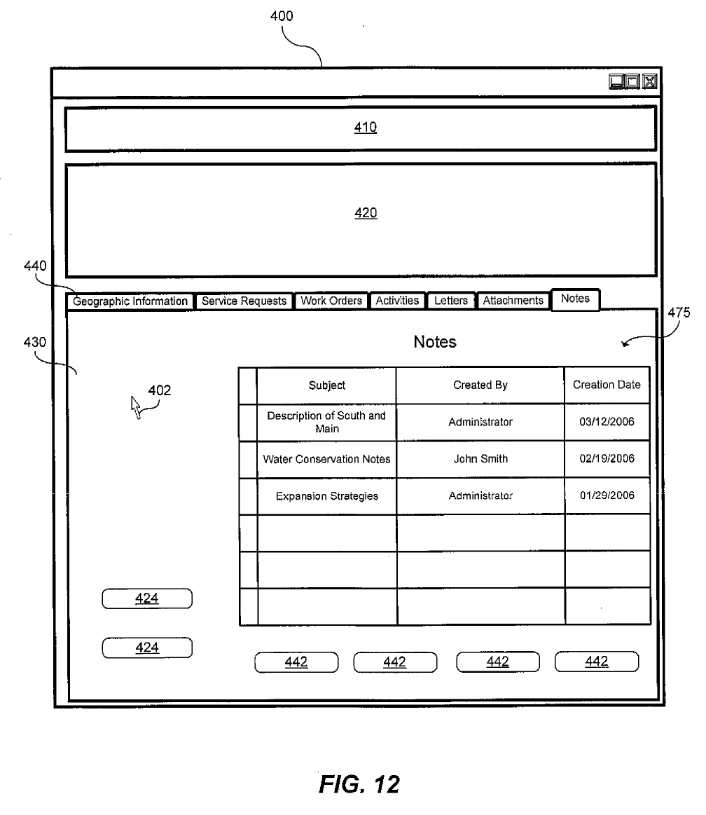

In addition, as illustrated in FIG. 12, a listing 475 of information relating to notes associated with a selected data element set 232 may be displayed within third display area 430 by selecting the data category tab 440 labeled “Notes.” In at least one embodiment, listing 475 comprises a plurality of data fields, one or more of which may be stored as a data element 236 in information database 230, as discussed in greater detail above. Examples of the type of data and information that may be entered or stored in each data field of listing 475 include, without limitation, a description of the subject matter of the note, the name of the individual who created the note, and the date on which the note was created. In certain embodiments, one or more files containing each note displayed in listing 475 may be stored as a data element 236 in information database 230 and displayed as an attachment in third display area 430.

Moreover, although not illustrated, a listing of information relating to hand-drawn or computer created drawings associated with a selected data element set 232 may be displayed within third display area 430 by selecting a data category tab 440 labeled “Drawings.” In at least one embodiment, this listing may comprise a plurality of data fields, one or more of which may be stored as a data element 236 in information database 230, as discussed in greater detail above. Examples of the type of data and information that may be entered or stored in each data field of this exemplary listing include, without limitation, a description of the subject matter of the drawing, the name of the individual who created the drawing, and the date on which the drawing was created. In certain embodiments, one or more files containing each drawing displayed in the exemplary listing in third display area 430 may be stored as a data element 236 in information database 230 and displayed as an attachment in third display area 430.

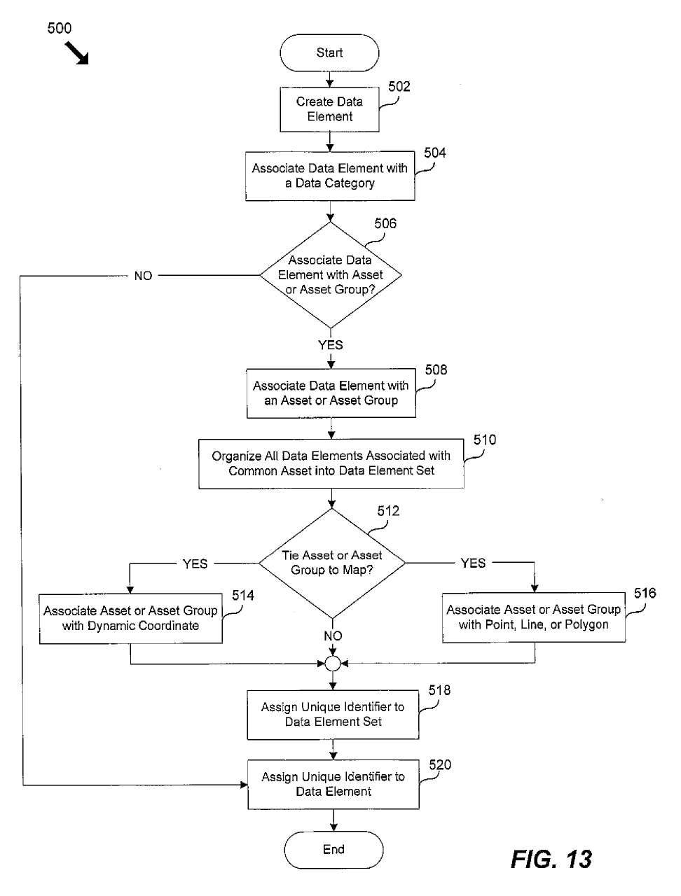

FIG. 13 is a flow diagram 500 of an exemplary method for managing assets. As illustrated in this figure, this exemplary method may comprise creating a data element at step 502 and associating this data element with a data category at step 504, as described in greater detail above. Although steps 502 and 504 are illustrated as separate steps, these steps may also be combined into a single step. In other words, a data category may be assigned to a data element at the time the data element is created. At decision point 506, a user and/or an administrator of the exemplary asset management system may determine whether to associate the data element created in step 502 with an asset (such as a piece of property, a gas line, or an irrigation valve) or a group of assets (such as a subdivision). If so, the data element may be associated with an asset or asset group at step 508 in accordance with one or more of the exemplary embodiments previously described herein. Otherwise, control proceeds to step 520.

At step 510, each data element that is associated with or linked to the same asset (such as a gas line) may be organized into and classified within a common data element set. Accordingly, in at least one embodiment, every data element within a single data element set is associated with or linked to a common (i.e., the same) asset, At decision point 512, a user and/or an administrator of the exemplary asset management system may determine whether the asset or group of assets tied to the data element in step 508 should be tied to a map. That is, the user or administrator may determine whether to associate geographically referenced information with the asset. If so, the asset or group of assets may either be associated with a dynamic coordinate at step 514 or with a point, line, or polygon at step 516 in accordance with the principles of one or more of the exemplary embodiments previously described herein. Otherwise, control proceeds to step 518 where a unique identifier may be assigned to the data element set, as described in greater detail above. Subsequently, at step 520, a unique identifier may be assigned to the data element created in step 502, as described in greater detail above. Upon completion of step 520, the exemplary method may terminate.

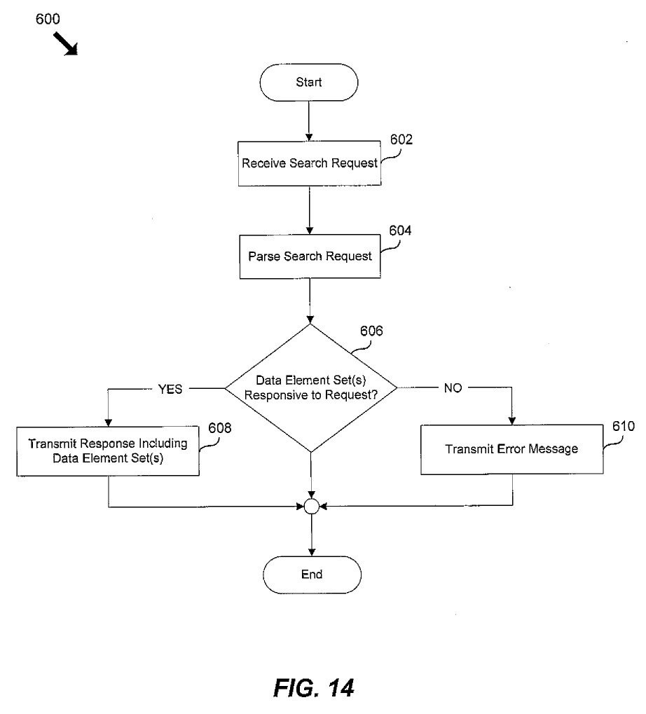

FIG. 14 is a flow diagram 600 of an exemplary method for identifying one or more data element sets responsive to a search request. As illustrated in this figure, at step 602 a search request may be received. In at least one embodiment, this search request may be received from a user of the asset management system via a user input device or an access device, such as access devices 202, 204, and 206. In certain embodiments, this search request may contain one or more query terms relating to attributes of a data element set. Examples of such query terms might include, for example, a unique identifier associated with a data element set, the name of a data category associated with a data element set, and/or a description of information contained in data elements associated with a data element set (such as, for example, the owner information associated with a piece of property, the name of a street, or the like).

At step 604, the search request may be parsed using techniques known to those of ordinary skill in the art. At step 606, each data element 236 stored within information database 230 may then be searched to determine whether any attributes, information, data, or files contained in any data elements 236, data categories 234, or data element sets 232 are responsive to any of the query terms in the search request. The method and manner of determining whether any data element sets 232 are responsive to one or more of the query terms contained in the search request may be performed in any number of ways; including, for example, by determining whether any of the query terms appear within any of the data elements 236, data categories 234, or data element sets 232 stored in information database 230. In certain embodiments, a data element set 232 may be determined to be responsive to one or more query terms contained in a search request if one or more of the data categories 234 and/or data elements 236 associated with this data element 236 are determined to be responsive to one or more of the query terms associated with the search request.

If one or more data element sets 232 are identified as being responsive to the search request, then at step 608 a response is transmitted to a user. In at least one embodiment, this response contains the one or more data element sets 232 that were determined to be responsive to the search request. Otherwise, an error message is transmitted to the user at step 610 indicating that responsive data element sets were not located. Upon completion of step 608 or step 610, the exemplary method may terminate.

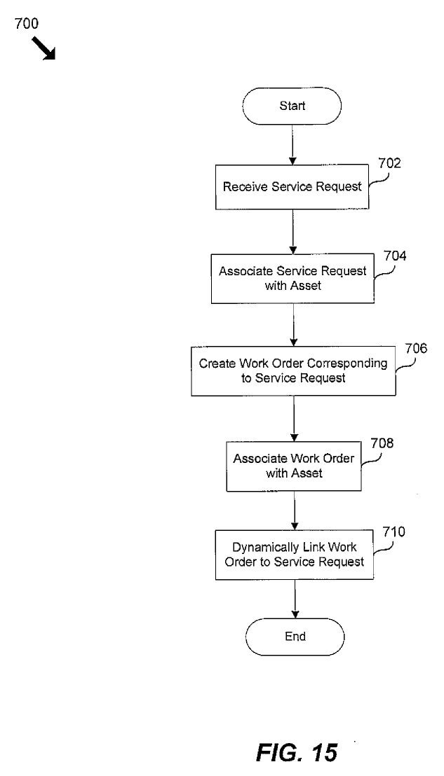

FIG. 15 is a flow diagram 700 of an exemplary method for dynamically associating a work order with a corresponding service request. As seen in this figure, at step 702 a service request may be received, either from a client (such as a homeowner) or an administrator. At step 704, this service request may be associated with an asset, as described in greater detail above. At step 706, a work order corresponding to the service request received in step 702 may be created. At step 708, the work order created in step 706 may be associated with the same asset with which the service request received in step 702 is associated. At step 710, one or more data fields of the work order may be dynamically associated with or linked to one or more of the data fields contained in the service request created in step 702. In other words, the work order created in step 706 may be dynamically associated with the service request received in step 702 such that, when a data field is edited in the service request, a corresponding data field contained in the work order may be updated accordingly, or vice versa.

Although the exemplary methods illustrated in FIGS. 13-15 have been described with a certain degree of particularity, many modifications and variations are possible. For example, the order of one or more of the steps and/or decision points depicted in these figures may be rearranged. In addition, one or more of the steps or decision points depicted in these figures may be deleted, combined, or otherwise modified as needed.

The preceding description has been provided to enable others skilled in the art to best utilize various aspects of the exemplary embodiments described herein. This exemplary description is not intended to be exhaustive or to be limited to any precise form disclosed. Many modifications and variations are possible without departing from the spirit and scope of the instant disclosure. It is desired that the embodiments described herein be considered in all respects illustrative and not restrictive and that reference be made to the appended claims and their equivalents for determining the scope of the instant disclosure. In addition, for ease of use, the words “including” and “having,” as used in the specification and claims, are interchangeable with and have the same meaning as the word “comprising.”

What is claimed is:

1. A computer-implemented method for managing assets, comprising:
providing an information database comprising a plurality of data elements;
associating at least one data element in the information database with a first asset;
organizing each data element associated with the first asset into a first data element set;
associating each data element in the first data element set with at least one data category;
simultaneously displaying each data category associated with each data element in the first data element set.

2. The method of claim 1, further comprising selectively displaying, by data category, each data element in the first data element set.

3. The method of claim 1, further comprising associating the first asset with at least one of a point, a line, and a polygon on a map.

4. The method of claim 1, further comprising associating the first asset with a dynamic coordinate on a map.

5. The method of claim 1, further comprising:
associating at least one data element in the information database with a first group of assets;
organizing each data element associated with the first group of assets into a second data element set.

6. The method of claim 1, further comprising assigning a unique identifier to each data element set in the information database.

7. The method of claim 1, wherein the at least one data element is at least one of an asset attribute, a service request, a work order, a letter, a task, a phone call record, a facsimile, an e-mail, a document, a billing record, a global positioning point, a maintenance schedule, a warranty information record, a construction record, a freehand drawing, and a user definable record.

8. The method of claim 1, further comprising remotely accessing the information database over a communication network.

9. The method of claim 1, further comprising:
receiving a request comprising at least one query term;
selectively identifying one or more data element sets responsive to the at least one query term;
transmitting a response including the one or more selectively identified data element sets.

10. The method of claim 1 further comprising:
associating a service request comprising a plurality of data fields with a second asset;
creating a work order corresponding to the service request, the work order comprising a plurality of data fields;
associating the work order corresponding to the service request with the second asset;
dynamically linking at least one data field of the service request to at least one data field of the work order corresponding to the service request.

11. An asset management system, comprising:
a display interface;
an information database in communication with the display interface, the information database comprising:
a first data element set comprising at least one data element;
at least one data category associated with each data element in the first data element set;
wherein each data element in the first data element set is associated with a first asset;
wherein the display interface enables the simultaneous display of each data category associated with each data element in the first data element set.

12. The system of claim 11, wherein the first asset is associated with a dynamic coordinate on a map.

13. The system of claim 11, wherein the first asset is associated with at least one of a point, a line, and a polygon on a map.

14. The system of claim 11, further comprising a unique identifier assigned to each data element set in the information database.

15. The system of claim 11, wherein the display interface forms a portion of an access device in communication with the information database over a communication network.

16. The system of claim 15, wherein the information database is configured to generate and transmit a response to the access device based upon a request transmitted from the access device, the request comprising at least one query term and the response comprising at least one data element set responsive to the request.

17. The system of claim 11, wherein the display interface is configured to selectively display, by data category, each data element in the first data element set.

18. The system of claim 11, wherein the first data element set comprises:
a service request comprising a plurality of data fields; and
a work order corresponding to the service request and comprising a plurality of data fields;
wherein at least one data field of the service request is dynamically linked to at least one data field of the work order corresponding to the service request.

19. A computer program product, encoded on a computer-readable medium, for managing assets, the computer program product comprising:
a first set of machine-readable instructions, executable on a computer system, configured to associate at least one data element in an information database with a first asset;
a second set of instructions, executable on the computer system, configured to organize each data element associated with the first asset into a first data element set;
a third set of instructions, executable on the computer system, configured to associate each data element in the first data element set with at least one data category;
a fourth set of instructions, executable on the computer system, configured to simultaneously display each data category associated with each data element in the first data element set.

20. A computer-implemented method for managing assets, comprising:
providing an information database comprising a plurality of data elements;
associating at least one data element in the information database with a first asset;
associating the first asset with a dynamic coordinate oh a map;
organizing each data element associated with the first asset into a first data element set;
assigning a unique identifier to the first data element set;
associating each data element in the first data element set with at least one data category;
simultaneously displaying each data category associated with the first data element set;
selectively displaying, by data category, each data element in the first data element set.
